(19) United States
(12) Patent Application Publication
(10) Pub. No.: US 2014/0324302 A1
(43) Pub. Date: Oct. 30, 2014

(54) Method of Estimating Mass of a Payload in a Hauling Machine

(71) Applicant: CATERPILLAR INC., Peoria, IL (US)

(72) Inventors: Balmes Tejeda, Peoria, IL (US); Amit Jayachandran, Peoria, IL (US); Michael Mitchell, Aurora, IL (US); Andrew DeHaseth, Morton, IL (US); James W. Landes, East Peoria, IL (US)

(73) Assignee: Caterpillar Inc., Peoria, IL (US)

(21) Appl. No.: 13/871,376

(22) Filed: Apr. 26, 2013

(51) Int. Cl. G01G 19/08

(52) U.S. Cl. CPC G01G 19/086
USPC 701/51

(57) ABSTRACT

A method implemented by a programmable controller to estimate the payload mass in a bed of a moving hauling machine. The method includes determining whether the machine is at a steady acceleration and grade, estimating transmission torque, calculating axle torque at at least one of the ground engaging elements, calculating force at said ground engaging element, determining the acceleration of the machine, calculating mass of the machine with the payload, adjusting the calculated mass of the machine with the payload based upon an estimated machine mass and rolling resistance, and providing an estimate of the mass of the payload.

### TECHNICAL FIELD

This patent disclosure relates generally to payload hauling machines, and, more particularly to methods of estimating the mass of carried by a payload hauling machine.

### BACKGROUND

Hauling machines are utilized in various industries to transport a payload from one location to another. In order to operate such machines efficiently, it is desirable to carry an optimally sized payload. Loading a machine to less than full capacity may result excess costs associated with unnecessary runs and the acceleration of maintenance schedules. Overloading a machine may result in increased wear and costly maintenance.

Numerous methods have been proposed for determining the mass of payloads in hauling machines. While physically weighing a machine on a scale and then deducting the weight of the machine itself may be a reliable method of measuring a payload, such an arrangement is not practical in large machines. Moreover, physically weighing a machine is generally not possible in the field.

European Patent Application Publication 0 356 067 to Kirby discloses a method of calculating the mass of a vehicle utilizing the equation weight is equal to force divided by acceleration, that is, W=f/a, adjusted based upon calculations utilized to obtain the values for force and acceleration. Kirby proposes the measurement of acceleration based upon an inertial accelerometer, by measurements associated with a braking mechanism, or by the deformation or twisting of a drive train member measured by magnetic markers mounted a propeller shaft of a road vehicle. The twisting of the shaft results in a delay between signals from the markers, wherein the time interval is proportional to the accelerating force. Kirby further proposes that force be determined from a sensor arrangement in conjunction with a time signal from a speedometer arrangement wherein the machine is traveling on a level ground at a constant acceleration between two speeds. Kirby indicates that resulting constants in the calculation may be evaluated in a known weight machine and eliminated by calibration such that weight of the vehicle may be calculated using the above equation.

### SUMMARY

The disclosure describes, in one aspect, a method, implemented by a programmable controller in a hauling machine having moveable ground engaging elements and a bed. The method estimates a payload contained in the bed during forward movement of the machine. The method includes determining whether the machine is at a steady acceleration and grade, estimating transmission torque, calculating axle torque at at least one of the ground engaging elements, calculating force at said ground engaging element, determining the acceleration of the machine, calculating mass of the machine with the payload, adjusting the calculated mass of the machine with the payload based upon an estimated machine mass and rolling resistance, and providing an estimate of the mass of the payload.

The disclosure describes, in another aspect, a non-transitory computer- readable medium including computer-executable instructions facilitating performing a method, implemented by a programmable controller, of estimating a payload contained in a bed of a hauling machine having moveable ground engaging elements during forward movement of the machine. The method includes determining whether the machine is at a steady acceleration and grade, estimating transmission torque, calculating axle torque at at least one of the ground engaging elements, calculating force at said ground engaging element, determining the acceleration of the machine, calculating mass of the machine with the payload, adjusting the calculated mass of the machine with the payload based upon an estimated machine mass and rolling resistance, and providing dynamic payload estimate.

The disclosure describes, in yet another aspect, a hauling machine having a plurality of moveable ground engaging elements, a bed adapted to carry a payload, a transmission adapted to operate in a plurality of gears, an accelerometer adapted to indicate current operational status of the machine, and a programmable controller. The programmable controller is configured by computer-executable instructions to estimate a mass of a payload contained in the bed during forward movement of the machine using a set of parameters including: operational status of the transmission, length of time in the current gear, grade, throttle position, currently machine acceleration operational status, parameters of at least one ground engaging element, empty machine mass, and estimated rolling resistance.

### BRIEF DESCRIPTION OF THE DRAWING(S)

While the appended claims set forth the features of the present invention with particularity, the invention and its advantages are best understood from the following detailed description taken in conjunction with the accompanying drawings, of which:

FIG. 1 is a diagrammatical side elevational view of an articulated truck machine/vehicle, which is illustrated as one example of a machine suitable for incorporating a method of estimating the mass of a payload in accordance with the disclosure;

FIG. 2 is a box diagram representation of a programmable controller and inputs to the controller for an exemplary machine in accordance with aspects of methods of the disclosure;

FIG. 3 is a flowchart summarizing operation of an exemplary method carried out by a programmable controller to determine the reliability of a method of estimating the mass of a payload in accordance with the disclosure;

FIG. 4 is a flowchart summarizing operation of an exemplary method carried out by a programmable controller to estimate the mass of a payload of a hauling machine in accordance with the disclosure;

FIG. 5 is a flowchart summarizing operation of an exemplary strategy for determining the mass of a payload of a hauling machine incorporating the methods of FIGS. 3 and 4; and

FIG. 6 is a flowchart summarizing operation of an exemplary strategy for determining the mass of a payload of a hauling machine incorporating the methods of FIGS. 3-5.

### DETAILED DESCRIPTION

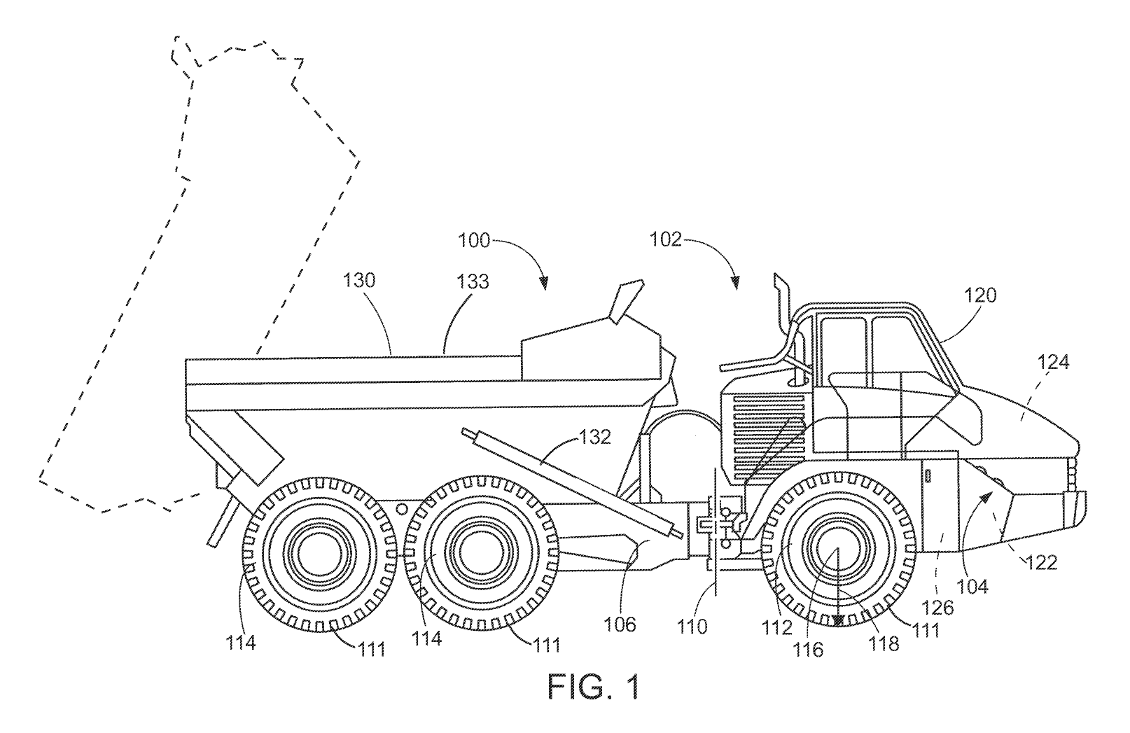

This disclosure relates to hauling machines and the determination of the mass of a carried payload. FIG. 1 that provides a schematic side elevational view of one example of a machine 100 incorporating a machine payload control strategy according to the disclosure. In the illustration of FIG. 1, the machine 100 is a truck, which is one example for a machine to illustrate the concepts of the described machine payload control strategy. While the arrangement is illustrated in connection with a truck, the arrangement described herein has potential applicability in various other types of payload hauling machines, such as wheel loaders, motor graders, etc. The term “machine” refers to any machine that performs some type of operation associated with an industry such as mining, construction, farming, transportation, or any other industry known in the art. For example, the machine may be a dump truck, backhoe, grader, material handler or the like. The term vehicle is intended to incorporate substantially the same scope as the term machine, in that a vehicle is a machine that travels.

Referring to FIG. 1, the illustrated machine 100 is an articulated truck 102 that includes front and rear frame portions 104, 106 coupled at an articulation axis 110, and supported on ground engaging elements 111, such as front wheels 112 and/or rear wheels 114. The front frame portion 104 supports a cab 120, and, typically, a drive system 122. The drive system 122 typically includes an internal combustion engine 124 configured to transmit power to a transmission 126. The transmission in turn may be configured to transmit power to the ground engaging elements 111 (e.g., front wheels 112) by way of axle 116 using any known means. The wheel 112 has a radius 118, which corresponds to the rolling radius 118 of the driven wheel on a driven surface (e.g., the distance from the center of the driven wheel 112 to the ground).

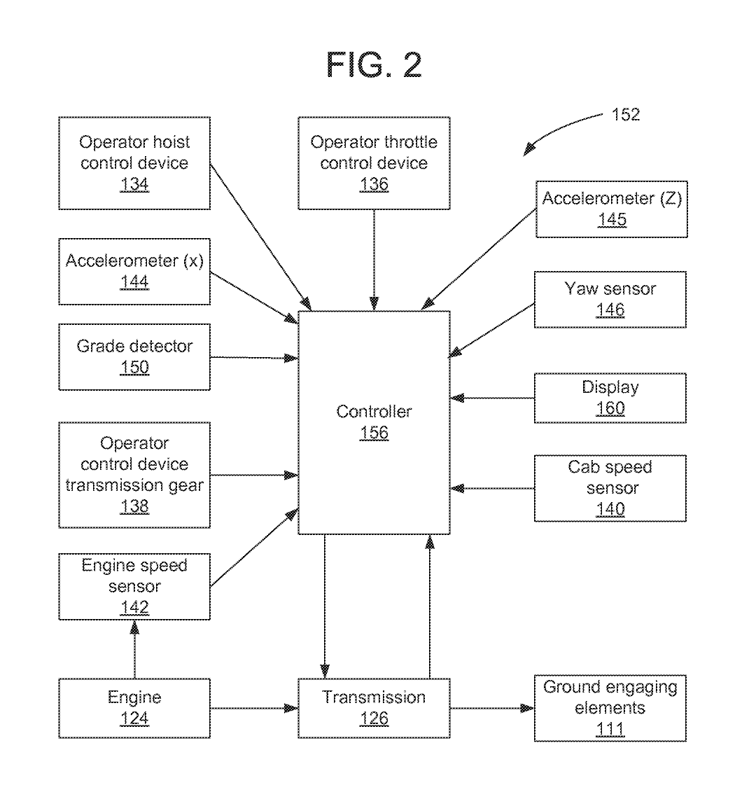

The rear frame portion 106 supports a bed 130. In the illustrated machine 100, the bed 130 may be selectively pivoted between a load position (illustrated) and an unload position (shown in phantom) by one or more hoist cylinders 132 in response to commands from operator hoist control 134 (see FIG. 2) typically located in the cab 120. While an articulated truck 102 with a pivoted bed 130 is illustrated, aspects of this disclosure may apply to other load hauling machines including, for example, unarticulated machines, or machines including a bed that incorporates a dumping plate that may be actuated by one or more dump cylinders to similarly push a payload 133 contained in the bed 130.

The machine 100 may include additional operator controls, such as a throttle 136, and a transmission gear control 138 by which an operator may choose a particular gear from a given selection of gears (see FIG. 2). The machine 100 may additionally include a plurality of gauges and/or sensors associated with operation of the machine 100, such as a cab speed sensor 140, engine speed sensor 142, accelerometer(s) associated with the fore and aft direction (X) 144 and the vertical direction (Y) 145, and/or yaw sensor 146. The machine 100 may further include sensors adapted to sense environmental characteristics. For example, the machine 100 may include a tilt sensor, inclinometer, or grade detector 150. While each of these controls and sensors is illustrated diagrammatically in the simplified box diagram of a control system 152 in FIG. 2, the machine 100 may include additional, different, or less controls and sensors.

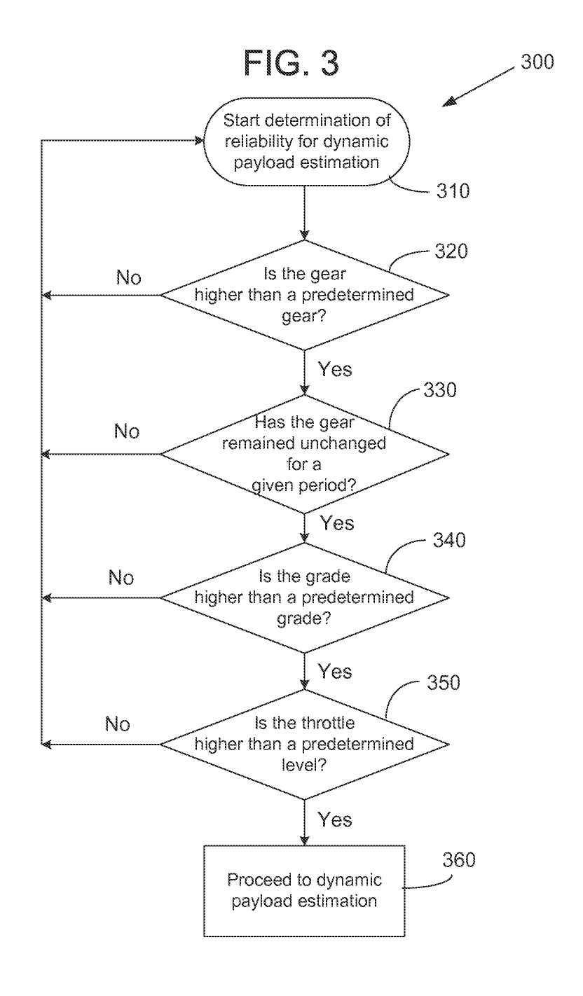

The controls and sensors provide signals indicative of the respective control or sensed feature to a programmable controller 156. During operation of the machine 100, the controller 156 may be configured to receive and process information relating to operation of the machine 100 and to provide a determination of the mass of a payload 133 carried by the machine 100 during dynamic operation by methods described with regard to FIGS. 3-6. The determined mass may be communicatively coupled, for example, to a display 160 within the cab 120 or to a remote operation or monitoring location (not shown). For the purpose of this disclosure, the terms “dynamic operation” or “dynamic conditions” will refer to operations and conditions wherein the machine 100 is moving as a result of operation of the drive system 122 to power ground engaging elements 111, such as the front wheels 112 and/or rear wheels 114.

The controller 156 may include a processor (not shown) and a memory component (not shown). The processor may be microprocessors or other processors as known in the art. In some embodiments, the processor may be made up of multiple processors. Instructions associated with the methods described may be read into, incorporated into a computer readable medium, such as the memory component, or provided to an external processor. In alternative embodiments, hard-wired circuitry may be used in place of or in combination with software instructions. Thus, embodiments are not limited to any specific combination of hardware circuitry and software.

The term “computer-readable medium” as used herein refers to any medium or combination of media that participates in providing instructions to processor for execution. Such a medium may take many forms, including but not limited to, non-volatile media, volatile media, and transmission media. Non-volatile media includes, for example, optical or magnetic disks. Volatile media includes dynamic memory. Transmission media includes coaxial cables, copper wire and fiber optics.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, or any other medium from which a computer or processor can read.

The memory component may include any form of computer-readable media as described above. The memory component may include multiple memory components.

The controller 156 may be a part of a control module may be enclosed in a single housing. In alternative embodiments, the control module may include a plurality of components operably connected and enclosed in a plurality of housings. In still other embodiments the control module may be located in single location or a plurality of operably connected locations including, for example, being fixedly attached to the machine 100 or remotely to the machine 100.

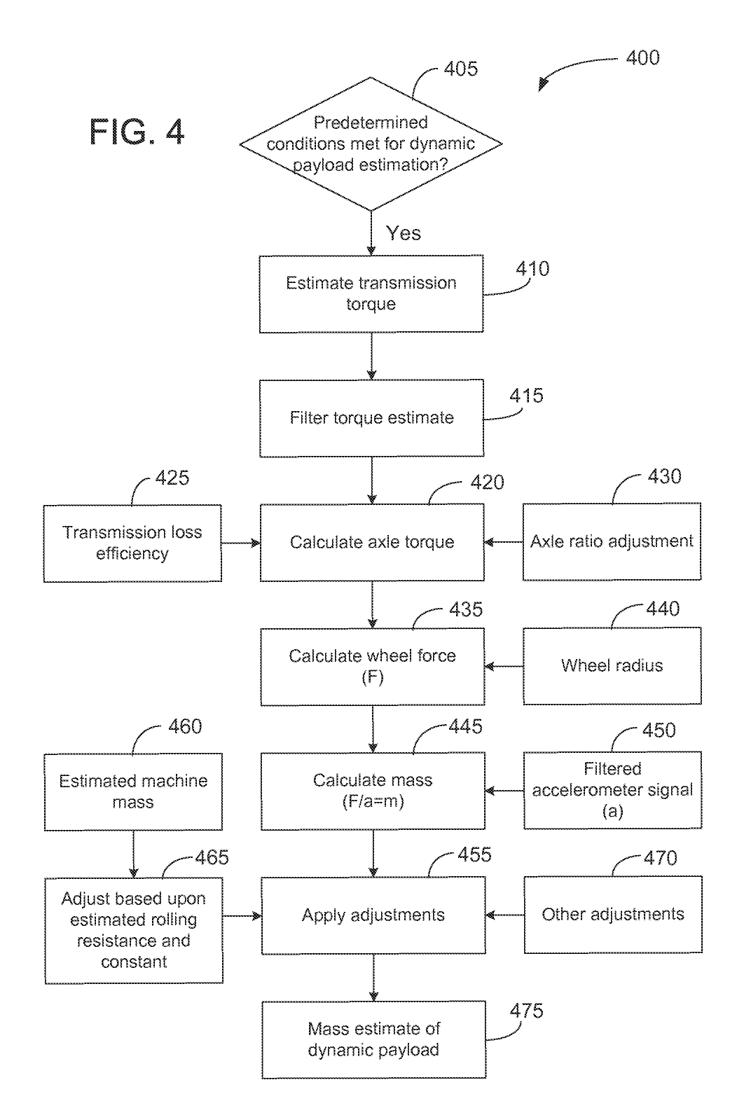

Turning now to FIGS. 3 and 4, there is illustrated an exemplary control strategy for determination of the mass of a dynamic payload 133. The strategy includes two aspects, that is, the determination of whether appropriate conditions exist for the valid calculation of an estimated mass of a dynamic payload 133 (FIG. 3), and the calculation of the estimated mass (FIG. 4). While the various steps are illustrated and discussed in a particular order, those of skill will appreciate that the steps may be performed in an alternate order in order to arrive at the final dynamic payload estimate unless otherwise specifically noted. For example, while the strategy first illustrates the determination of whether conditions exist allowing for a valid calculation, followed by the actual calculation based upon various input, the strategy could likewise be executed by first performing the actual calculation, followed by a determination of whether the calculation is valid, or the strategies may be performed simultaneously.

In order for the calculation of the estimated mass of the payload 133 during dynamic conditions to be valid, the machine 100 must be operating in a relatively high torque situation, and at or near a steady acceleration and grade. Referring to the strategy 300 as illustrated in FIG. 3, the determination of the reliability of the dynamic payload 133 is initiated by any appropriate mechanism at box 310. While the steps of the specific inquiries are illustrated and explained in a particular order, the steps may be performed in an alternate order, including simultaneously.

Referring to decision box 320, in order to reliably estimate the payload 133 during dynamic conditions, the controller 156 determines whether the transmission 126 is operating in a gear greater than a predetermined gear. Further, in order to ensure that the gear operation is not a transient operation, the controller 156 determines whether the transmission 126 has been maintained in that operating gear for at least a given period (see decision box 330). If either of these requirements is not satisfied, then estimation of the payload mass during dynamic conditions will not be considered reliable.

Information regarding the operation of the transmission 126 may be provided by any appropriate mechanism. For example, in some embodiments, the controller 156 directs operation of the transmission 126, including the operating gear utilized, and may include the determination of the time in a given gear. Additionally or alternatively, sensors or the like associated with the transmission 126 may provide signals indicative of the operating gear as well as time in that gear.

Referring to decision box 340, the controller 156 determines if the machine 100 is operating on a grade that is higher than a predetermined grade. By way of example only, an appropriate predetermined grade may be 6%. Grade may be determined by any appropriate mechanism. For example, a tilt sensor, inclinometer, or grade detector 150 may provide a signal indicative of the grade to the controller 156. Alternately, the grade may be calculated by any appropriate data, such as, for example, a calculation based upon a signal from an accelerometer. An estimation of the payload mass during dynamic conditions will be reliable only if the machine 100 is operating on at least a given grade.

Further, the machine 100 must be operating with the throttle in a position higher than a predetermined level in order for the estimation to be reliable. Throttle position may be determined by any appropriate mechanism. For example, a sensor may be provided, or the operator control for the throttle 136 may provide a signal indicative of the throttle position to the controller 156 from which the controller 156 may compare the throttle position to the predetermined level in order to determine if the resultant estimation of the payload mass during dynamic conditions will be reliable. An appropriate throttle position may be, for example, near full throttle.

Although not illustrated in FIG. 3, the arrangement may further include arrangements for monitoring whether or not the sensors are working A situation under which a sensor may no longer be operative may be, for example, if a wire has been cut.

Turning to FIG. 4, there is illustrated a strategy 400 for calculation of an estimated mass of a payload 133 during dynamic conditions wherein the machine 100 is operating in a relatively high torque situation, and at or near a steady acceleration and grade, i.e., as may be determined by the strategy 300 set forth in FIG. 3. As identified by decision box 405, the calculation will be reliable only if the operation of the machine 100 satisfies these predetermined conditions. While decision box is disposed at the beginning of the strategy 400 set forth in FIG. 4, it could likewise be disposed at any position or following the calculation of the estimated mass.

As indicated in box 410, the output torque from the transmission 126 is estimated. The torque may be estimated or calculated by any appropriate method, device(s) or machine operating parameter values. For example, a dynamic estimator may utilize an engine torque signal broadcast by an engine ECM. The torque may be estimated based upon machine operating parameter values including reported engine torque, speed ratio (ratio of torque converter input to converter output), and engine speed. As indicated in box 415, the estimated torque from the transmission 126 may be filtered, applying a filter constant based upon the particulars of the machine 100 in order to obtain a signal indicative of the transmission torque.

As indicated at box 420, in order to calculate the torque applied at an axle 116 of wheel 112, the signal indicative of the transmission torque is multiplied by a force factor based upon transmission loss efficiency (box 425), and an axle ratio adjustment 430. The axle ratio adjustment 430 may be based upon a gear ratio to the axle 116. To determine the force (F) applied at the wheel 112 (see box 435), the torque applied at the axle 116 is divided by the radius 118 of the wheel 112 (see box 440).

An accelerometer 144 disposed at the bed 130 of the machine 100 is provides a signal indicative of acceleration in the X direction at the bed 130, that is, in the fore and aft direction. A filter constant is utilized to filter the signal from the accelerometer 144 to provide a filtered accelerometer signal (see box 445) indicative of acceleration (a).

The mass of the machine 100 including the payload 133 (box 445) is calculated by dividing the force (F) at the wheels 112 by the acceleration (a) based upon the filtered accelerometer signal (box 450). Adjustments are made to the calculated mass of the machine 100 with payload 133 (box 455) to account for the mass of the machine 100. An estimated mass of the unloaded machine 100 (box 460) is adjusted based upon estimated rolling resistance of the machine 100 and prior mass calculations (box 465) and subtracted from the estimated mass of the machine 100 including the payload 133 to provide an initial estimate of the mass of the dynamic payload 133. Other adjustments may likewise be made based upon specifics of the machine 100 and prior calculations of mass (box 470) to provide the final estimate of the mass of the dynamic payload 133 at box 475.

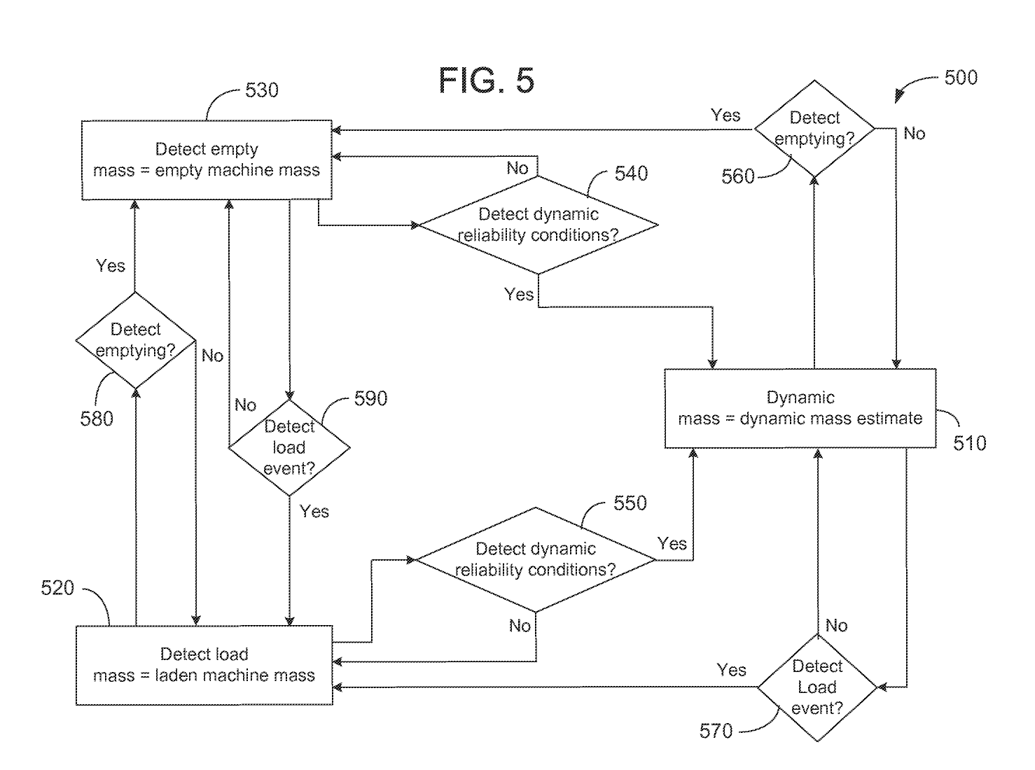

The strategy for estimating the dynamic mass of a payload 133 of a machine 100 may be a part of a larger strategy or integration algorithm for estimating the mass of a payload 133 of a machine 100. Turning to FIG. 5, there is shown an exemplary integration strategy 500 for the estimation of the mass of a payload 133 during various conditions. The integration strategy 500 may include a strategy (box 510) for determining a dynamic mass estimate, along with a strategy (box 520) related to a loading event, and a strategy (box 530) related to an emptying event. In this way, while the machine 100 is operating, functions the programmable controller 156 monitors various functions and parameters of the machine 100 and the environment to determine what, if any mass determination is appropriate. The calculated, estimated mass may be utilized in algorithms for continued determinations related to the machine 100.

More specifically, a strategy 510 for determining the mass of a carried payload 133 during dynamic conditions may be utilized to estimate the mass if it is detected at either decision box 540 or decision box 550 that the conditions exist for reliably determining a dynamic mass estimate. A strategy 300 such as is illustrated in FIG. 3 may be utilized at decision boxes 540 and 550 to detect and determine if conditions exist to reliably estimate a dynamic mass. Likewise, a strategy 400 such as is illustrated in FIG. 4 may be utilized to calculate the dynamic mass of a payload 133 (see box 510).

From the determination of a dynamic mass estimate (box 510), if emptying of the bed 130 is detected (decision box 560), the strategy 530 directed to an emptying event may be applied to determine whether the bed 130 is empty, there is no payload 133 contained in the bed 130. Conversely, if a load event is detected (decision box 570), the strategy 520 directed to a loading event may be applied to determine if a loading event is occurring.

Similarly, from the determination of a loading event by the strategy 520, if the conditions are detected for the reliable determination of a dynamic mass estimate (decision box 550), then the strategy 510 for the determination of the mass under dynamic conditions may be applied. Conversely, if an emptying event is detected (decision box 580), the strategy 530 directed to an emptying even may be applied to determine whether the bed 130 is empty.

Finally, from the determination of an emptying event by the strategy 530, if the conditions are detected for the reliable determination of a dynamic mass estimate (decision box 540), then the strategy 510 for the determination of the mass under dynamic conditions may be applied. Again, conversely, if a load event is detected (decision box 590), the strategy 520 directed to a loading event may be applied to determine if a loading event is occurring.

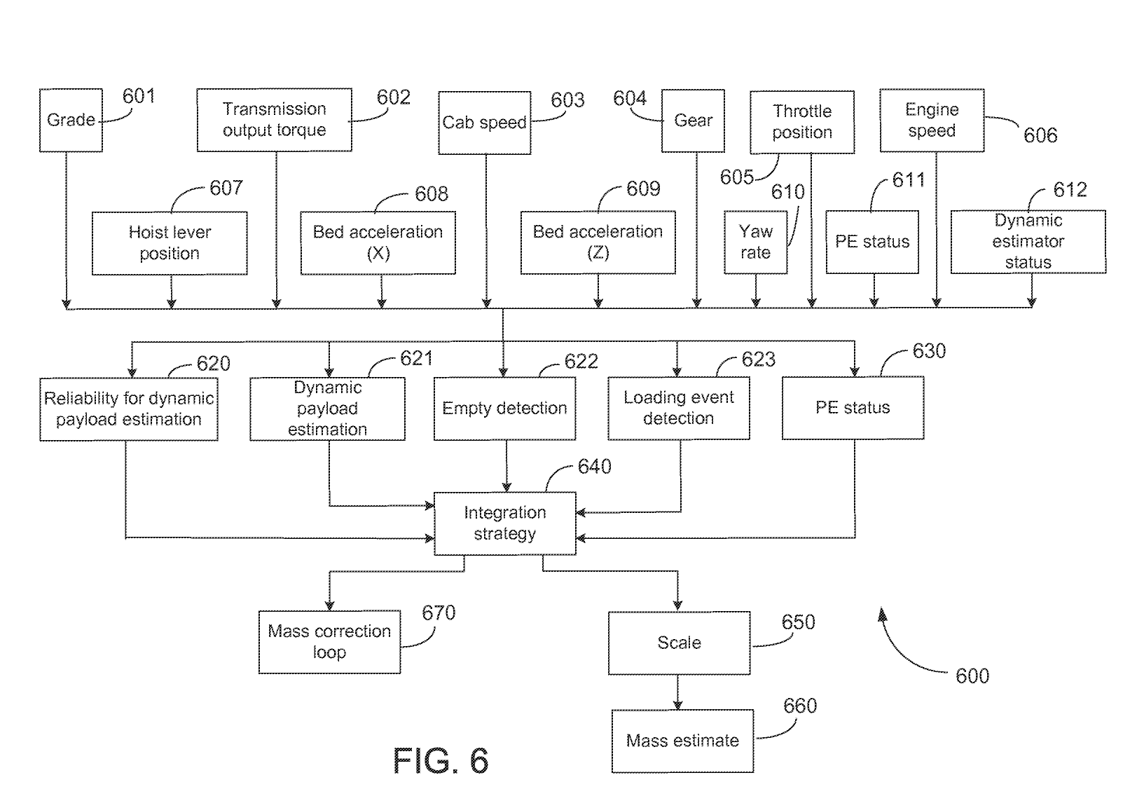

The integration strategy 500 of FIG. 5 is shown the context of the larger context of a top-level algorithm 600 in FIG. 6. Information may be provided from various sources, such as, for example, those illustrated in FIG. 2. By way of example only, information may be provided regarding the grade (box 601) from the grade detector 150, transmission output torque (box 602) based upon calculations or information from the transmission 126, cab speed (box 603) from the cab speed sensor 140, gear (box 604) based upon the operator transmission gear control 138, throttle position (box 605) based upon a sensor or the operator control device for the throttle 136, engine speed (box 606) based upon the engine speed sensor 142, hoist lever position (box 607) based upon a sensor or the operator hoist control 134, bed acceleration in the X and Z directions (boxes 608 and 609) based upon accelerometers 144, 145, and the yaw rate (box 610) based upon a yaw sensor 146. Further, in an embodiment, any appropriate mechanism may be utilized to provide an indication of whether sensors and other devices providing information are in working condition (see, for example, PC status 611 and dynamic estimator status 612).

From the information provided, individual strategies 620-623 may be applied for determining the reliability of a dynamic payload mass estimation, estimating a dynamic payload mass, emptying detection, and loading event detection. Again, an embodiment may further include any appropriate mechanism for providing an indication that all individual strategies are proceeding (box 630). From the operation of the individual strategies 620-623 along with the integration strategy (box 640) such as the integration strategy 500 illustrated in FIG. 5, an estimated mass is determined. The estimated mass is then scaled (box 640) for delivery to a data link module (not illustrated) to provide a broadcast mass estimate (box 650).

Further, the estimated mass obtained may be utilized in the additional algorithms, as indicated by box 670, the mass correction loop. For example, an estimated mass of the machine 100 and payload 133 may be utilized in calculations and estimates related to the rolling resistance of the machine 100, as utilized in boxes 460 and 465 in the strategy illustrated in FIG. 4.

### Industrial Applicability

The present disclosure is applicable to machines 100 including a bed 130 for carrying a payload 133. Embodiments of the disclosed strategy may have the ability to estimate payload mass without the use of any other weight sensors.

Some embodiments may take into account appropriate losses for one or more of the factors utilized to calculate an estimated force (F) at the wheels 105.

The strategy for calculating the mass of a dynamic payload 133 may be utilized at opportune times when the calculation will be accurate.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. In a hauling machine having moveable ground engaging elements and a bed, a method, implemented by a programmable controller, of estimating a payload contained in the bed during forward movement of the machine, the method comprising:
determining whether the machine is at a steady acceleration and grade, estimating transmission torque,
calculating axle torque at at least one of the ground engaging elements,
calculating force at said ground engaging element,
determining the acceleration of the machine,
calculating mass of the machine with the payload,
adjusting the calculated mass of the machine with the payload based upon an estimated machine mass and rolling resistance, and
providing an estimate of the mass of the payload.

2. The method of claim 1 wherein the step of determining whether the machine is at a steady acceleration and grade includes
determining if the transmission is at a gear higher gear than a predetermined gear, and
determining if the gear has not been changed within a given period of time.

3. The method of claim 1 wherein the step of determining whether the machine is at a steady acceleration and grade includes determining whether the machine is on a grade higher than a predetermined grade.

4. The method of claim 1 wherein the step of determining whether the machine is at a steady acceleration and grade includes determining if the throttle position is higher than a predetermined level.

5. The method of claim 2 wherein the step of determining whether the machine is at a steady acceleration and grade includes
determining whether the machine is on a grade higher than a predetermined grade, and
determining if the throttle position is higher than a predetermined level.

6. The method of claim 5 further including
filtering the transmission torque estimate,
calculating axle torque based upon the torque estimate, estimated transmission loss efficiency, and an axle ratio adjustment,
wherein the ground engaging element is a wheel and the step of force at said ground engaging element includes calculating wheel force based upon a radius of the wheel, and
determining the acceleration of the machine includes filtering an accelerometer signal.

7. The method of claim 1 further including
filtering the transmission torque estimate,
calculating axle torque based upon the torque estimate, estimated transmission loss efficiency, and an axle ratio adjustment,
wherein the ground engaging element is a wheel and the step of force at said ground engaging element includes calculating wheel force based upon a radius of the wheel, and
determining the acceleration of the machine includes filtering an accelerometer signal.

8. The method of claim 1 further including filtering the transmission torque estimate.

9. The method of claim 1 wherein the step of calculating axle torque includes calculating axle torque based upon the torque estimate, estimated transmission loss efficiency, and an axle ratio adjustment.

10. The method of claim 1 wherein the step of force at said ground engaging element includes calculating force at the ground engaging element based upon the distance from an axle of the ground engaging element to ground.

11. The method of claim 6 wherein the step of force at said ground engaging element includes calculating force at the ground engaging element based upon the distance from an axle of the ground engaging element to ground.

12. The method of claim 1 wherein the ground engaging element is a wheel and the step of force at said ground engaging element includes calculating wheel force based upon a radius of the wheel.

13. The method of claim 1 wherein the step of determining the acceleration of the machine includes filtering an accelerometer signal.

14. The method of claim 1 further including at least one of detecting if the bed is empty and detecting if a loading event is occurring.

15. A non-transitory computer-readable medium including computer-executable instructions facilitating performing a method, implemented by a programmable controller, of estimating a payload contained in a bed of a hauling machine having moveable ground engaging elements during forward movement of the machine, the method comprising:
determining whether the machine is at a steady acceleration and grade, estimating transmission torque,
calculating axle torque at at least one of the ground engaging elements,
calculating force at said ground engaging element,
determining the acceleration of the machine,
calculating mass of the machine with the payload,
adjusting the calculated mass of the machine with the payload based upon an estimated machine mass and rolling resistance, and
providing an estimate of the mass of the payload.

16. The non-transitory computer-readable medium of claim 15 wherein the step of determining whether the machine is at a steady acceleration and grade includes
determining if the transmission is at a gear higher gear than a predetermined gear, and
determining if the gear has not been changed within a given period of time.

17. The non-transitory computer-readable medium of claim 15 wherein the step of determining whether the machine is at a steady acceleration and grade includes determining whether the machine is on a grade higher than a predetermined grade.

18. The non-transitory computer-readable medium of claim 15 wherein the step of determining whether the machine is at a steady acceleration and grade includes determining if the throttle position is higher than a predetermined level.

19. A hauling machine comprising
a plurality of moveable ground engaging elements,
a bed adapted to carry a payload,
a transmission adapted to operate in a plurality of gears,
an accelerometer adapted to indicate current operational status of the machine,
a programmable controller configured by computer-executable instructions to estimate a mass of a payload contained in the bed during forward movement of the machine, the programmable controller using a set of parameters including:
operational status of the transmission,
length of time in the current gear,
grade,
throttle position,
currently machine acceleration operational status,
parameters of at least one ground engaging element,
empty machine mass, and
estimated rolling resistance.

20. The hauling machine of claim 19 wherein the set of parameters further includes an estimate of torque from the transmission.
